(19) United States
(12) Patent Application Publication
(10) Pub. No.: US 2008/0101263 A1
(43) Pub. Date: May 1, 2008

(54) Single-ended to differential duplexer filter

(75) Inventors: Bradley Paul Barber, Acton, MA (US); Hao Zhang, Brighton, MA (US)

Correspondence Address: FARJAMI & FARJAMI LLP, 26522 LA ALAMEDA AVENUE, SUITE 360, MISSION VIEJO, CA, 92691, US

(73) Assignee: Skyworks Solutions, Inc.

(21) Appl. No.: 11/801,446

(22) Filed: May 10, 2007

Related U.S. Application Data
(60) Provisional application No. 60/855,476, filed on Oct. 30, 2006.

(51) Int. Cl. H04B 1/69

(52) U.S. Cl. 370/282

(57) ABSTRACT

According to an exemplary embodiment, a duplexer includes a single-ended to differential filter, where the single-ended to differential filter includes a ladder stage coupled to an antenna port of the duplexer. The single-ended to differential filter further includes a balun stage coupled to the ladder stage. The single-ended to differential filter further includes a lattice stage coupled to the balun stage, where the balun stage is configured to provide single-ended to differential signal conversion between the ladder stage and the lattice stage. The lattice stage can be coupled to differential receive ports of the duplexer. The duplexer can further include a single-ended to single-ended filter coupled between the antenna port and a transmit port of the duplexer.

### BACKGROUND OF THE INVENTION

The present application claims the benefit of and priority to a pending provisional patent application entitled “Single-Ended to Differential Duplexer,” Ser. No. 60/855,476 filed on Oct. 30, 2006. The disclosure in that pending provisional application is hereby incorporated fully by reference into the present application.

1. Field of the Invention

The present invention is generally in the field of electrical circuits. More particularly, the invention is in the field of duplexers.

2. Background Art

A duplexer is typically a three-port network that can allow a transmitter and a receiver in a communications system, such as a code-division multiple access (CDMA) or a wideband CDMA (WCDMA) communications system, to use the same antenna. The duplexer typically uses sharply tuned filters, such as narrow pass-band and notch filters, to isolate the transmitter from the receiver, which allows both the transmitter and receiver to operate concurrently on the same antenna, at different frequencies, without the transmitter interfering with the receiver. Typically, duplexers, such as RF (radio frequency) antenna duplexers, include single-ended filters, which have a single input or output port with its impedance referenced to ground. It is, however, desirable in some radio architectures to have duplexers in which the receive side of the duplexer includes a filter having a single-ended input port and a differential output port (hereinafter referred to as a “single-ended to differential filter” in the present application).

In one conventional approach, a single-ended to differential filter for a receive side of a duplexer can include a ladder stage, which can include series and shunt resonators, such as bulk acoustic wave (BAW) resonators, coupled together in a “ladder” arrangement. The ladder stage can be coupled to a balun stage for single-ended to differential signal conversion at the filter output. However, using a balun stage at the output of the filter can undesirably increase signal loss in the receive signal path of the duplexer and add considerable size and cost to the filter.

In another conventional approach, a single-ended to differential filter for a receive side of a duplexer can include a balun stage at the filter input coupled to a lattice stage at the filter output. The lattice stage can include, for example, two series and two shunt resonators, such as BAW resonators, where the each of the series resonators provide a separate signal path and the shunt resonators are coupled between the series resonators in a “crisscross” arrangement. However, placing balun stage at the input of the single-ended to differential filter can cause undesirable loading of the transmit side of the duplexer, thereby increasing signal loss in the transmit signal path.

### SUMMARY OF THE INVENTION

Single-ended to differential duplexer filter, substantially as shown in and/or described in connection with at least one of the figures, as set forth more completely in the claims.

### BRIEF DESCRIPTION OF THE DRAWINGS

FIG. 1 shows a block diagram of a conventional exemplary single-ended to differential filter in a conventional exemplary duplexer.

FIG. 2 shows a block diagram of a conventional exemplary single-ended to differential filter in a conventional exemplary duplexer.

FIG. 3 shows a block diagram of an exemplary single-ended to differential filter in an exemplary duplexer, in accordance with one embodiment of the present invention.

FIG. 4 shows a circuit diagram of an exemplary single-ended to differential filter, in accordance with one embodiment of the present invention.

FIG. 5 shows a block diagram of an exemplary single-ended to differential receive filter and an exemplary differential to single-ended transmit filter in an exemplary duplexer, in accordance with one embodiment of the present invention.

### DETAILED DESCRIPTION OF THE INVENTION

The present invention is directed to a single-ended to differential duplexer filter. The following description contains specific information pertaining to the implementation of the present invention. One skilled in the art will recognize that the present invention may be implemented in a manner different from that specifically discussed in the present application. Moreover, some of the specific details of the invention are not discussed in order to not obscure the invention. The specific details not described in the present application are within the knowledge of a person of ordinary skill in the art.

The drawings in the present application and their accompanying detailed description are directed to merely exemplary embodiments of the invention. To maintain brevity, other embodiments of the invention which use the principles of the present invention are not specifically described in the present application and are not specifically illustrated by the present drawings.

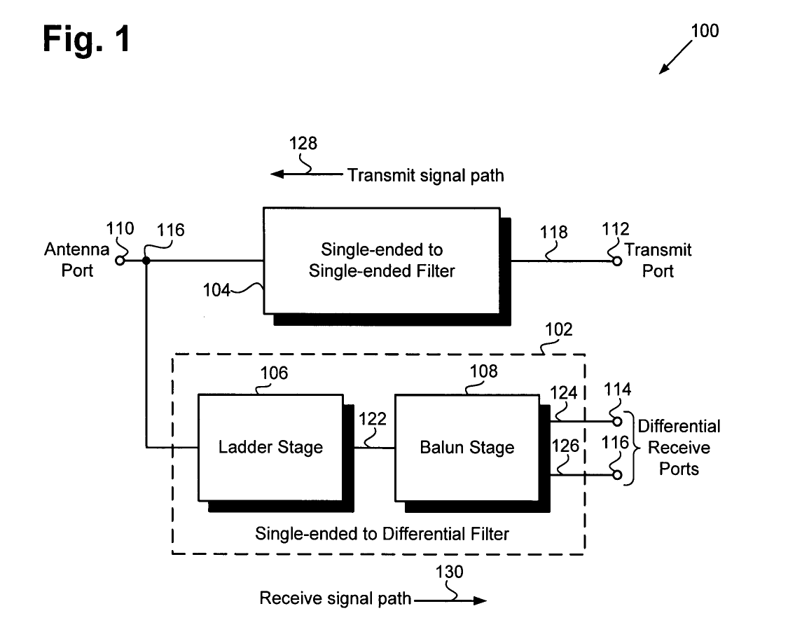

FIG. 1 shows a block diagram of conventional duplexer 100 including conventional single-ended to differential receive filter 102 (also referred to simply as “single-ended to differential filter 102” in the present application) and single-ended to single-ended transmit filter 104 (also referred to simply as “single-ended filter 104” in the present application). Conventional single-ended to differential filter 102 includes ladder stage 106 and balun stage 108. Conventional duplexer 100 has antenna port 110 and transmit port 112, which are single-ended ports, and differential receive ports 114 and 116. For example, antenna port 110 can be coupled to an antenna (not shown in FIG. 1), transmit port 112 can be coupled to an output of a transmitter (also not shown in FIG. 1), such as a power amplifier, and differential receive ports 114 and 116 can be coupled to differential inputs of a receiver (also not shown in FIG. 1), such as a low noise amplifier (LNA). Conventional duplexer 100 can be utilized in a communications system, such as a CDMA or WCDMA communications system, to allow a transmitter and a receiver to utilize the same antenna concurrently by utilizing different frequency bands for the transmitter and receiver.

As shown in FIG. 1, transmit signal path 128 extends through single-end filter 104 from transmit port 112 to antenna port 110 on the transmit side of conventional duplexer 100, and receive signal path 130 extends through conventional single-ended to differential filter 102 from antenna port 110 to differential receive ports 114 and 116 on the receive side of conventional duplexer 100. Also shown in FIG. 1, the output of single-ended filter 104 is coupled to the input of ladder stage 106 of conventional single-ended to differential filter 102 and antenna port 110 of conventional duplexer 100 at node 116, and input 118 of single-ended filter 104 is coupled to transmit port 112 of conventional duplexer 100. Single-ended filter 104 can be configured as a band-pass filter to provide low loss in transmit signal path 128 for signals having frequencies in a transmit frequency band and to highly suppress or reject signals having frequencies outside of the transmit frequency band. In the present application, the “transmit frequency band” refers to the range of transmission frequencies of a transmitter coupled to the transmit port of the duplexer.

Further shown in FIG. 1, output 122 of ladder stage 106 is coupled to balun stage 108 of conventional single-ended to differential filter 102 and differential outputs 124 and 126 of balun stage 108 are coupled to respective differential receive ports 114 and 116 of conventional duplexer 100. Ladder stage 106 can comprise series and shunt resonators (not shown in FIG. 1), such as BAW resonators, coupled together in a “ladder” filter arrangement in a manner known in the art. Ladder stage 106 can be configured as a band-pass filter to provide low loss in receive signal path 130 for signals having frequencies in a receive frequency band and to highly suppress signals outside of the receive frequency band. In the present application, the “receive frequency band” refers to the range of operational frequencies of a receiver, such as an LNA, coupled to differential receive ports of the duplexer.

Balun stage 108 can comprise, for example, an isolation transformer (not shown in FIG. 1), and can be configured to convert output 122, i.e., a single-ended output, to differential outputs 124 and 126, which are balanced outputs. However, by placing balun stage 108 at the output of conventional single-ended to differential filter 102, it (i.e. balun stage 108) can cause an undesirable amount of signal loss in conventional single-ended to differential filter 102, thereby undesirably decreasing the performance of conventional duplexer 100.

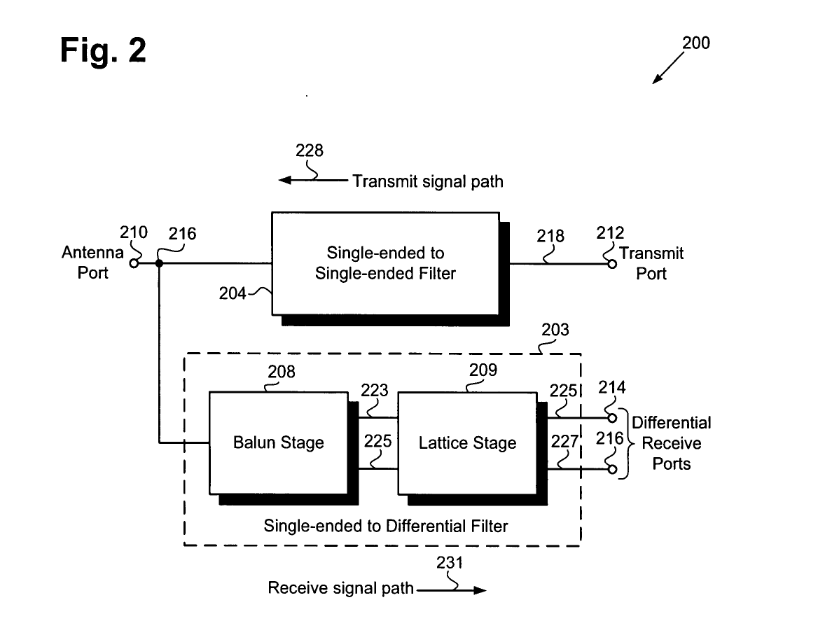

FIG. 2 shows a block diagram of conventional duplexer 200 including conventional single-ended to differential filter 203 and single-ended to single-ended filter 204 (also referred to simply as “single-ended filter 204” in the present application). In FIG. 2, single-ended filter 204, balun stage 208, antenna port 210, transmit port 212, differential receive ports 214 and 216, receive signal path 231, and transmit signal path 228 correspond, respectively, to single-ended filter 104, balun stage 108, antenna port 110, transmit port 112, differential receive ports 114 and 116, receive signal path 130, and transmit signal path 128 in FIG. 1. Conventional duplexer 200 can be utilized in a similar manner as conventional duplexer 100 in FIG. 1. In conventional single-ended to differential filter 203, balun stage 208 is coupled to lattice stage 209.

As shown in FIG. 2, transmit signal path 228 extends through single-end filter 204 from transmit port 212 to antenna port 210 on the transmit side of conventional duplexer 200 and receive signal path 231 extends through conventional single-ended to differential filter 203 from antenna port 210 to differential receive ports 214 and 216 on the receive side of conventional duplexer 200. Also shown in FIG. 2, single-ended filter 204 is coupled between transmit port 212 and antenna port 210 and can be configured in a similar manner as single-filter 104 in conventional duplexer 100 in FIG. 1. Also shown in FIG. 2, the input of balun stage 208 is coupled to the output of single-ended filter 204 and antenna port 210 at node 216, differential outputs 223 and 225 of balun stage 208 are coupled to corresponding differential inputs of lattice stage 209, and differential outputs 225 and 227 of lattice stage 209 are coupled to respective differential receive ports 214 and 216 of conventional duplexer 200.

Balun stage 208 can comprise, for example, an isolation transformer (not shown in FIG. 2), and can be configured to convert a single-ended input from antenna port 210 to differential outputs 223 and 225, which are balanced outputs. Lattice stage 209 can comprise, for example, two series and two shunt resonators (not shown in FIG. 2), such as BAW (bulk acoustic wave) resonators, where the each of the series resonators provide a separate signal path and the shunt resonators are coupled between the series resonators in a “crisscross” arrangement. Lattice stage 209 can be configured as a band-pass filter to provide low loss for signals in receive signal path 231 having frequencies in a receive frequency band and to highly suppress or reject signals outside of the receive frequency band.

However, by placing balun stage 208 at the input of conventional single-ended to differential filter 203, it (i.e. balun stage 208) can undesirably increase signal loss in transmit signal path 228 by loading the transmit side of the duplexer at the output of single-ended filter 204. As a result, placing balun stage 208 at the input of conventional single-ended to differential filter 203 can undesirably decrease the performance of conventional duplexer 200.

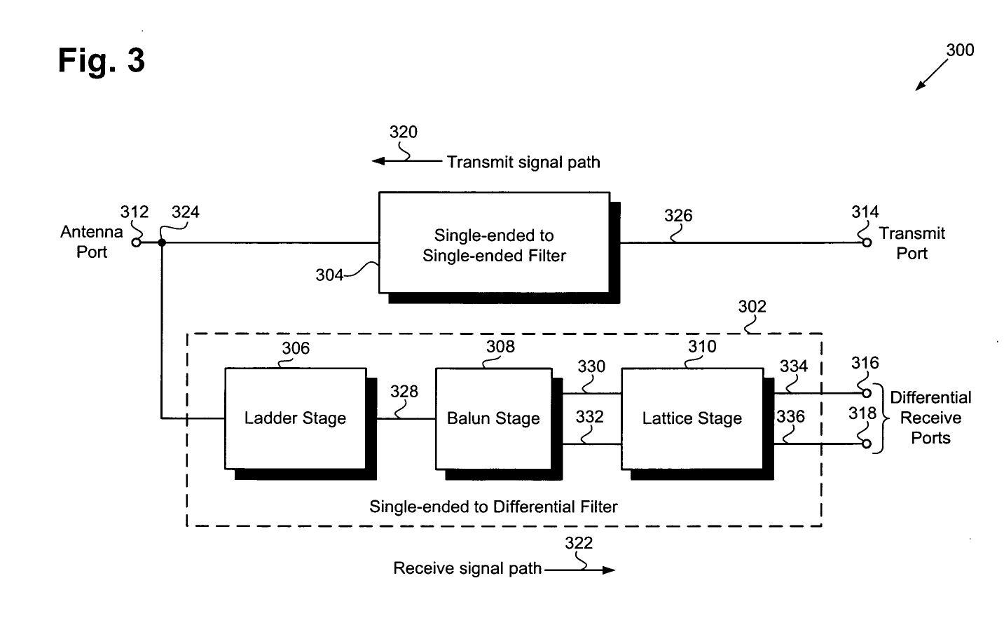

FIG. 3 shows a block diagram of duplexer 300 in accordance with one embodiment of the present invention. Duplexer 300 includes single-ended to differential filter 302 and single-ended to single-ended filter 304 (also referred to simply as “single-ended filter 304” in the present application). Single-ended to differential filter 302 includes ladder stage 306, balun stage 308, and lattice stage 310. Duplexer 300 has antenna port 312 and transmit port 314, which are single-ended ports, and differential receive ports 316 and 318, which are balanced ports. For example, antenna port 312 can be coupled to an antenna (not shown in FIG. 3), transmit port 314 can be coupled to an output of a transmitter (also not shown in FIG. 3), such as a power amplifier, and differential receive ports 316 and 318 can be coupled to differential inputs of a receiver (also not shown in FIG. 3), such as an LNA (low noise amplifier). Duplexer 300 can be utilized in a communications system, such as a CDMA or WCDMA communications system, to allow a transmitter and a receiver to utilize the same antenna concurrently.

As shown in FIG. 3, transmit signal path 320 extends from transmit port 314 through single-ended filter 304 to antenna port 312 on the transmit side of duplexer 300 and receive signal path 322 extends from antenna port 312 through single-ended to differential filter 302 to differential receive ports 316 and 318 on the receive side of the duplexer. Thus, signals inputted into transmit port 314 from a transmitter (not shown in FIG. 3) can flow along transmit signal path 320 to antenna port 312 and signals inputted into antenna port 312 from an antenna (also not shown in FIG. 3) can flow along receive signal path 322 to a receiver (also not shown in FIG. 3) coupled to differential receive ports 316 and 318.

Also shown in FIG. 3, the output of single-ended filter 304 is coupled to the input of ladder stage 306 of single-ended to differential filter 302 and antenna port 312 of duplexer 300 at node 324, and input 326 of single-ended filter 304 is coupled to transmit port 314 of duplexer 300. Single-ended filter 304 can be configured as a band-pass filter to provide low loss in transmit signal path 320 for signals having frequencies in a transmit frequency band and to highly suppress or reject signals having frequencies outside of the transmit frequency band. Further shown in FIG. 3, single-ended output 328 of ladder stage 306 is coupled to the input of balun stage 308, and differential outputs 330 and 332 of balun stage 308, which are balanced outputs, are coupled to differential inputs of lattice stage 310.

Ladder stage 306 can include one or more “ladder” filters (not shown in FIG. 3), where each ladder filter can comprise a series resonator coupled to a shunt resonator. In the present embodiment, each of the series and shunt resonators can comprise a BAW (bulk acoustic wave) resonator. In other embodiments, each of the series and shunt resonators can comprise a surface acoustic wave (SAW) resonator, a thin-film bulk acoustic resonator (FBAR), or a combination of elements, such as inductors and capacitors. Ladder stage 306 can be configured to provide low loss for signals in receive signal path 322 having frequencies in a receive frequency band, and to highly suppress or reject signals having frequencies outside of the desired frequency range, such as frequencies in a transmit frequency band. Ladder stage 306 can also be configured to provide a very high impedance for signals in the transmit frequency band. As a result, single-ended to differential filter 302 causes only minimal loading on the transmit side of duplexer 300.

Balun stage 308 can comprise, for example, a pair of inductors and one or more capacitors (not shown in FIG. 3). In one embodiment, balun stage 308 can comprise an isolation transformer. Balun stage 308 can be configured to convert single-ended output 328 from ladder stage 306 to differential outputs 330 and 332, which are inputted into lattice stage 310. Also shown in FIG. 3, lattice stage 310 provides differential outputs 334 and 336, which are coupled to respective differential receive ports 316 and 318 of duplexer 300. Lattice stage 310 can comprise one or more “lattice” filters, where each lattice filter can comprise two series and two shunt resonators (not shown in FIG. 3), and where each of the series resonators provides a separate signal path and the shunt resonators are coupled between the series resonators in a “crisscross” arrangement. In the present embodiment, each of the series and shunt resonators can be a BAW resonator. In other embodiments, each of the series and shunt resonators can be a SAW resonator, an FBAR, or can be a combination of elements, such as inductors and capacitors. Lattice stage 310 can be configured as a band-pass filter to provide low loss in receive signal path 322 for signals having frequencies in a receive frequency band and to highly suppress or reject signals outside of the receive frequency band.

By utilizing a ladder stage coupled to a balun stage and a lattice stage coupled to the balun stage, an embodiment of the invention in FIG. 3 provides a single-ended to differential filter having low insertion loss and high out-of-band rejection on the receive side of a duplexer. In contrast, conventional single-ended to differential filter 102 causes an undesirable amount of signal loss on the receive side of conventional duplexer 100. The invention's single-ended to differential filter in FIG. 3 also provides a high impedance at the transmit frequency band, thereby causing only minimal loading on the transmit side of the duplexer. In contrast, conventional single-ended differential filter 203 can undesirably increase signal loss in transmit signal path by increasing the load on the transmit side of the duplexer, which decreases duplexer performance. Thus, an embodiment of the invention's single-ended to differential filter advantageously provides increased duplexer performance compared to conventional single-ended to differential filters 102 and 203 in FIGS. 1 and 2.

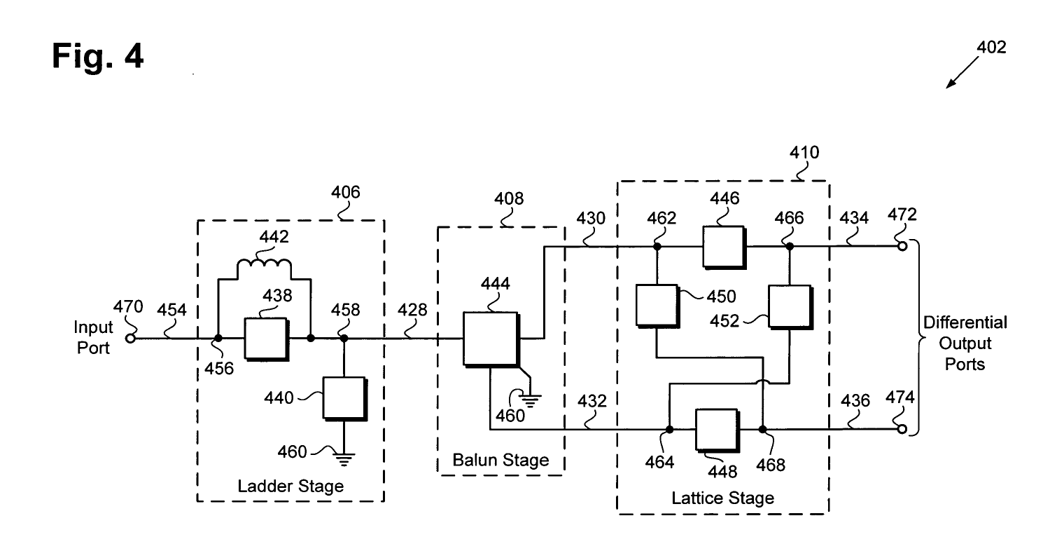

FIG. 4 shows a circuit diagram of single-ended to differential filter 402 according to one embodiment of the present invention. In FIG. 4, ladder stage 406, balun stage 408, lattice stage 410, single-ended output 428, and differential outputs 430, 432, 434, and 436 of single-ended to differential filter 402 correspond, respectively, to ladder stage 306, balun stage 308, lattice stage 310, single-ended output 328, and differential outputs 330, 332, 334, and 336 of single-ended to differential filter 302 in FIG. 3. In single-ended to differential filter 402, ladder stage 406 includes series resonator 438, shunt resonator 440, and inductor 442, balun stage 408 includes balun 444, and lattice stage 410 includes series resonators 446 and 448 and shunt resonators 450 and 452. In single-ended to differential filter 402, input 454 of ladder stage 406 can be coupled to antenna port 312 of duplexer 300 in FIG. 3, and differential outputs 434 and 436 of lattice stage 410 can be coupled to respective differential receive ports 316 and 318 of duplexer 300. In the present embodiment, single-ended to differential filter 402 can be fabricated on a single semiconductor die. In one embodiment, ladder stage 406 and lattice stage 410 of single-ended to differential filter 402 can be fabricated on a single semiconductor die.

As shown in FIG. 4, input port 470 of single-ended to differential filter 402 is coupled to input 454 of ladder stage 406. For example, input port 470 can be coupled to an antenna, which is not shown in FIG. 4. The input impedance of single-ended to differential filter 402, which can be measured between input port 470 and ground, can be, for example, approximately 50 ohms across the passband range of frequencies used by the filter. However, input impedance of single-ended to differential filter 402 can be optimized to match a desired load or antenna impedance that is coupled to input port 470. Also shown in FIG. 4, inductor 442 is coupled across first and second terminals of series resonator 438 at respective nodes 456 and 458, and respective first and second terminals of shunt resonator 440 are coupled to node 458 and ground 460. Inductor 442 and series resonator 438, which can function as a capacitor when operating outside of its designated frequency band, form a tank circuit, which can be configured to have a high impedance at a particular frequency, such as a transmit signal frequency of duplexer 300 in FIG. 3. As a result, ladder stage 406 can cause minimal loading on the transmit side of a duplexer, such as duplexer 300. The tank circuit formed by inductor 442 and series resonator 438 can also be configured to allow signals in a desired frequency band, such as a receive frequency band of duplexer 300, to pass through ladder stage 406 with minimal signal loss.

In one embodiment, shunt resonator 440 is not utilized. In one embodiment, ladder stage 406 can include a cascaded ladder filter comprised of a number of series resonators, such as series resonator 438, alternating with shunt resonators, such as shunt resonator 440. In one embodiment, ladder stage 406 can include a quarter wave line coupled to resonators to provide a high impedance at input port 470 of single-ended to differential filter 402 at a transmit frequency band. For example, ladder stage 406 can include a shunt resonator, such as shunt resonator 440, coupled between input 454 of ladder stage 406 and ground 460, and a quarter wave line coupled between input 454 of ladder stage 406 and a series resonator, such as series resonator 438. In one embodiment, ladder stage 406 can include an inductor and a series resonator, such as series resonator 438, where the inductor is coupled between input 454 of ladder stage 406 and ground 460 and the series resonator is coupled between input 454 and balun stage 408. In the present embodiment, series resonator 438 and shunt resonator 440 can each comprise a BAW resonator. In other embodiments, series resonator 438 and shunt resonator 440 can each comprise a SAW resonator, an FBAR, or a combination of elements, such as inductors and capacitors.

Also shown in FIG. 4, single-ended output 428 of ladder stage 406 is coupled to the input of balun 444 in balun stage 408 and differential outputs 430 and 432 are coupled to respective different inputs of lattice stage 410 at nodes 462 and 464. A ground terminal of balun 444 is coupled to ground 460. Balun 444 can comprise, for example, two inductors and one or more capacitors, which are not shown in FIG. 4. In one embodiment, the two inductors in balun 444 can be surface mount (SMT) inductors, which can provide increased performance. In that embodiment, the one or more capacitors can be fabricated on a single semiconductor die with ladder stage 406 and lattice stage 410, and the SMT inductors can be fabricated off-die. In one embodiment, balun 444 can comprise an isolation transformer. Balun 444 can be configured to convert single-ended output 428 to differential inputs for lattice stage 410.

Further shown in FIG. 4, in lattice stage 410, series resonators 446 and 448 and shunt resonators 450 and 452 are coupled together in a lattice configuration to form a lattice filter. In particular, a first terminal of shunt resonator 450 is coupled to a first terminal of series resonator 446 at node 462, a second terminal of shunt resonator 450 is coupled to a first terminal of series resonator 448 at node 468, a first terminal of shunt resonator 452 is coupled to a second terminal of series resonator 446 at node 466, and a second terminal of shunt resonator 452 is coupled to a second terminal of series resonator 448 at node 464. In the present embodiment, series resonators 446 and 448 and shunt resonators 450 and 452 can each comprise a BAW resonator. In other embodiments, series resonators 446 and 448 and shunt resonators 450 and 452 can each comprise a SAW resonator, an FBAR, or a combination of elements, such as inductors and capacitors. In one embodiment, lattice stage 410 can comprise two or more cascaded lattice filters, where each lattice filter can comprise two series resonators and two shunt resonators arranged in a lattice configuration. Lattice stage 410 can be configured as a band-pass filter to provide low loss for signals having frequencies in a desired frequency range, such as a receive frequency band in duplexer 300, and to highly suppress or reject signals outside of the desired frequency range, such as frequencies in a transmit frequency band in duplexer 300.

Also shown in FIG. 4, differential outputs 434 and 436 of lattice stage 410 are coupled to respective differential output ports 472 and 474 of single-ended to differential filter 402. For example, differential output port 472 can be a positive signal output port and differential output port 474 can be a negative signal output port. The output impedance of single-ended to differential filter 402, which can be measured between differential output ports 472 and 474, can be, for example, approximately 100 ohms.

By utilizing a balun stage, e.g., balun stage 408, coupled between a ladder stage, e.g., ladder stage 406, and a lattice stage, e.g., lattice stage 410, the invention's single-ended to differential filter, e.g., single-ended to differential filter 402, advantageously provides low insertion loss and high out-of-band rejection. Additionally, the invention's single-ended to differential filter can be advantageously utilized in a receive side of duplexer, such as duplexer 300 in FIG. 3, without significantly loading down the transmit side of the duplexer.

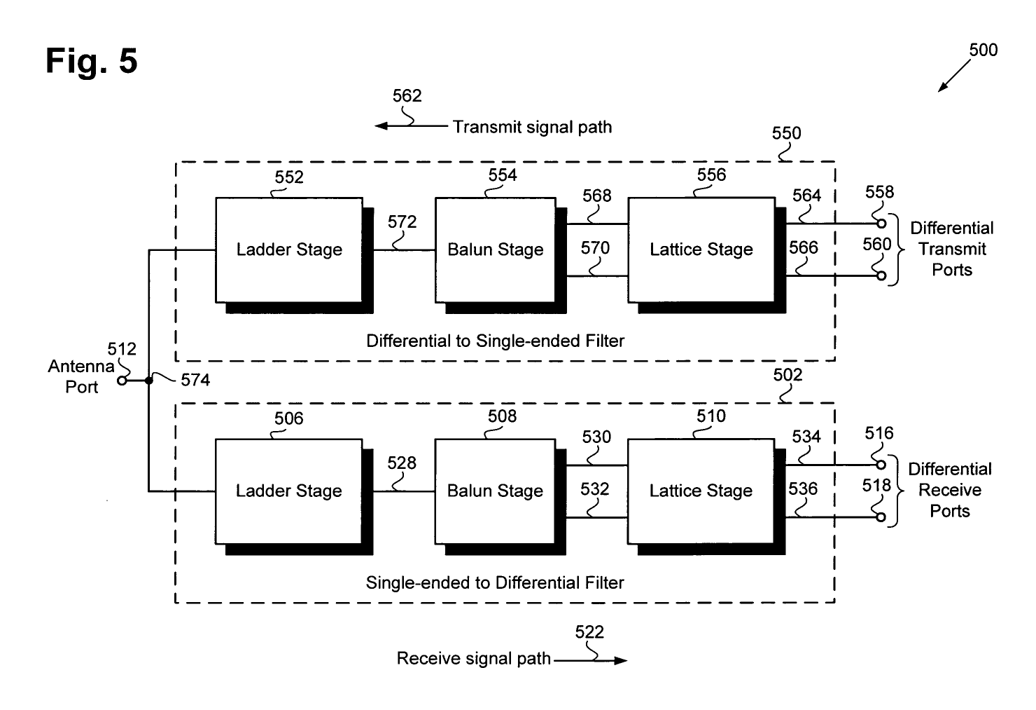

FIG. 5 shows a block diagram of duplexer 500 including single-ended to differential filter 502 and differential to single-ended filter 550 in accordance with one embodiment of the present invention. Differential to single-ended filter 550 has the same architecture as single-ended to differential filter 502. It (i.e. differential to single-ended filter 550) is referred as “differential to single-ended filter” because it is in transmit signal path 562 and used to convert a differential signal to a single-ended signal. However, differential to single-ended filter 550 is also referred to as a “single-ended to differential filter” in the present application. In FIG. 5, single-ended to differential filter 502, which is on receive side of duplexer 500 in receive signal path 522, corresponds to single-ended to differential filter 302 in FIG. 3. In particular, ladder stage 506, balun stage 508, lattice stage 510, single-ended output 528, and differential outputs 530, 532, 534, and 536 correspond, respectively, to ladder stage 306, balun stage 308, lattice stage 310, single-ended output 328, and differential outputs 330, 332, 334, and 336 in FIG. 3. Also, antenna port 512, differential receive ports 516 and 518, and receive signal path 522 in duplexer 500 correspond, respectively, to antenna port 312, differential receive ports 316 and 318, and receive signal path 322 in duplexer 300. Differential to single-ended filter 550 includes ladder stage 522, balun stage 554, and lattice stage 556.

Duplexer 500 has single-ended antenna port 512, differential receive ports 516 and 518, and differential transmit ports 558 and 560. For example, antenna port 512 can be coupled to an antenna (not shown in FIG. 5), differential transmit ports 558 and 560 can be coupled to differential outputs of a transmitter (also not shown in FIG. 5), such as a power amplifier, and differential receive ports 516 and 518 can be coupled to differential inputs of a receiver (also not shown in FIG. 5), such as an LNA. As shown in FIG. 5, transmit signal path 562 extends from different transmit ports 558 and 560 through differential to single-ended filter 550 to antenna port 512 on the transmit side of duplexer 500 and receive signal path 522 extends from antenna port 512 through single-ended to differential filter 502 to differential receive ports 516 and 518 on the receive side of the duplexer.

As shown in FIG. 5, differential inputs 564 and 566 of lattice stage 556 are coupled to respective differential transmit ports 558 and 560 and differential outputs 568 and 570 are coupled to balun stage 554. Lattice stage 556 can comprise substantially similar components and can have a substantially similar configuration as lattice stage 310 in FIG. 3. Lattice stage 556 can be configured as a band-pass filter to provide low insertion loss for signals in transmit signal path 562 having frequencies in a transmit frequency band and to highly suppress signals outside of the transmit frequency band (i.e. provide high out-of-band rejection). As also shown in FIG. 5, differential outputs 568 and 570 are coupled to balun stage 554 and single-ended output 572 from balun stage 554 is coupled to ladder stage 552. Balun stage 554 can comprise substantially similar components and can have a substantially similar configuration as balun stage 308 in FIG. 3. Balun stage 554 can be configured to convert differential outputs 568 and 570 to single-ended output 572.

Further shown in FIG. 5, single-ended output 572 is coupled to ladder stage 552 and the output of ladder stage 552 is coupled to antenna port 512 and the input of ladder stage 506 at node 574. Ladder stage 552 can comprise substantially similar components and can have a substantially similar configuration as ladder stage 306 in FIG. 3. Ladder stage 552 can be configured to provide a low insertion loss for signals in transmit signal path 562 having frequencies in a transmit frequency band, and to highly suppress or attenuate signals having frequencies outside of the desired frequency range. Ladder stage 552 can also be configured to provide a mismatched impedance for frequencies outside the transmit frequency band.

In the embodiment in FIG. 5, the invention provides a duplexer having a single-ended to differential filter in the receive signal path and a differential to single-ended filter in the transmit signal path of the duplexer, where the single-ended to differential filter (or the differential to single-ended filter) includes a ladder stage, a balun stage, and a lattice stage, thereby advantageously providing low insertion loss and high out-of-band rejection on transmit and receive sides of the duplexer. In one embodiment, the invention's differential to single-ended filter can be utilized on a transmit side of a duplexer in combination with a single-ended to single-ended receive side filter.

One or more of the invention's single-ended to differential filter, such as single-ended to differential filter 302 in the embodiment in FIG. 3 and/or differential to single-ended filter 550 in the embodiment in FIG. 5, can also be included in a multiplexer, which can include three or more filters coupled to an antenna port. For example, the multiplexer can include two duplexers, where each duplexer can include an embodiment of the invention's single-ended to differential filter, such as single-ended to differential filter 302 or differential to single-ended filter 550. The two duplexers can operate at different frequency bands and can each be coupled to the antenna port of the multiplexer. For example, the multiplexer can include a bank of two or more of the invention's single-ended to differential filters, where each single-ended to differential filter, such as single-ended to differential filter 302 in FIG. 3, operates at a different frequency band, and where the ladder stage in each single-ended to differential filter is designed to provide a minimal load on the other single-ended to differential filters. For example, the multiplexer can include a combination of one or more receive side filters and one or more transmit side filters. Each receive side filter in the multiplexer can be an embodiment of the invention's single-ended to differential filter, such as single-ended to different filter 302 in FIG. 3. Each transmit side filter can be an embodiment of the invention's differential to single-ended filter, such as differential to single-ended filter 550 in FIG. 5.

Thus, as discussed above, the invention provides a single-ended to differential filter utilizing ladder, balun, and lattice stages to provide low insertion loss and high out-of-band rejection in the receive and/or the transmit side of a duplexer. Additionally, if the invention's single-ended to differential filter is utilized on a receive side of a duplexer, it (i.e. the invention's single-ended to differential filter) causes only minimal loading on the transmit side of the duplexer, and vice versa. As a result, the invention's single-ended to differential filter increases duplexer performance compared to conventional single-ended to differential filters.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

Thus, a single-ended to differential duplexer filter has been described.

1. A duplexer including a single-ended to differential filter, said single-ended to differential filter comprising:
a ladder stage coupled to an antenna port of said duplexer;
a balun stage coupled to said ladder stage;
a lattice stage coupled to said balun stage;
wherein said balun stage is configured to provide single-ended to differential signal conversion between said ladder stage and said lattice stage.

2. The duplexer of claim 1, wherein said lattice stage is coupled to differential receive ports of said duplexer.

3. The duplexer of claim 1, wherein said lattice stage is coupled to differential transmit ports of said duplexer.

4. The duplexer of claim 1, wherein said ladder stage comprises at least one resonator selected from the group consisting of a bulk acoustic wave (BAW) resonator, a surface acoustic wave (SAW) resonator, and a thin-film bulk acoustic resonator (FBAR).

5. The duplexer of claim 1, wherein said lattice stage comprises at least one resonator selected from the group consisting of a bulk acoustic wave (BAW) resonator, a surface acoustic wave (SAW) resonator, and a thin-film bulk acoustic resonator (FBAR).

6. The duplexer of claim 1, wherein said ladder stage comprises a series resonator coupled in parallel with an inductor.

7. The duplexer of claim 1, wherein said ladder stage comprises a quarter wave line coupled to resonators.

8. The duplexer of claim 1, wherein said ladder stage comprises an inductor and a series resonator, wherein said inductor is coupled between said antenna port and ground and said series resonator is coupled between said antenna port and said balun stage.

9. A single-ended to differential filter comprising:
a ladder stage coupled to an antenna;
a balun stage coupled to said ladder stage;
a lattice stage coupled to said balun stage;
wherein said balun stage is configured to provide single-ended to differential signal conversion between said ladder stage and said lattice stage.

10. The single-ended to differential filter of claim 9, wherein said single-ended to differential filter is fabricated on a single semiconductor die.

11. The single-ended to differential filter of claim 9, wherein said ladder stage comprises at least one resonator selected from the group consisting of a bulk acoustic wave (BAW) resonator, a surface acoustic wave (SAW) resonator and a thin-film bulk acoustic resonator (FBAR).

12. The single-ended to differential filter of claim 9, wherein said lattice stage comprises at least one resonator selected from the group consisting of a bulk acoustic wave (BAW) resonator, a surface acoustic wave (SAW) resonator, and a thin-film bulk acoustic resonator (FBAR).

13. The single-ended to differential filter of claim 9, wherein said ladder stage comprises a series resonator coupled in parallel with an inductor.

14. The single-ended to differential filter of claim 9, wherein said ladder stage comprises a quarter wave line coupled to resonators.

15. The single-ended to differential filter of claim 9, wherein said ladder stage comprises an inductor and a series resonator, wherein said inductor is coupled between said antenna port and ground and said series resonator is coupled between said antenna port and said balun stage.

16. A multiplexer comprising:
at least three filters coupled to an antenna port of said multiplexer;
said at least three filters including at least one single-ended to differential filter, said at least one single-ended to differential filter comprising:
a ladder stage coupled to said antenna port of said multiplexer;
a balun stage coupled to said ladder stage;
a lattice stage coupled to said balun stage;
wherein said balun stage is configured to provide single-ended to differential signal conversion between said ladder stage and said lattice stage.

17. The multiplexer of claim 16, wherein said at least one single-ended to differential filter comprises at least two single-ended to differential filters, wherein at least one of said at least two single-ended to differential filters is situated in each of two duplexers.

18. The multiplexer of claim 16, wherein said at least one single-ended to differential filter comprises at least two single-ended to differential filters, wherein said lattice stage in each of said at least two single-ended to differential filters is coupled to one of at least two differential receive ports of said multiplexer.

19. The multiplexer of claim 16, wherein said ladder stage comprises at least one resonator selected from the group consisting of a bulk acoustic wave (BAW) resonator, a surface acoustic wave (SAW) resonator and a thin-film bulk acoustic resonator (FBAR).

20. The multiplexer of claim 16, wherein said lattice stage comprises at least one resonator selected from the group consisting of a bulk acoustic wave (BAW) resonator, a surface acoustic wave (SAW) resonator and a thin-film bulk acoustic resonator (FBAR).
